(19) United States
(12) Patent Application Publication
(10) Pub. No.: US 2012/0100306 A1
(43) Pub. Date: Apr. 26, 2012

(54) THIN FILM MANUFACTURING METHOD AND SILICON MATERIAL WHICH CAN BE USED IN THE METHOD

(75) Inventors: Yuma Kamiyama, Kyoto (JP); Kazuyoshi Honda, Osaka (JP); Yasuharu Shinokawa, Osaka (JP)

(73) Assignee: Panasonic Corporation, Kadoma-shi, Osaka (JP)

(21) Appl. No.: 13/379,282

(22) PCT Filed: Jul. 1, 2010
(86) PCT No.: PCT/JP2010/004343

§ 371 Date: Dec. 19, 2011

(30) Foreign Application Priority Data
Jul. 2, 2009 (JP) 2009-157614

(51) Int. Cl. B05D 3/06; C01B 33/02; B05D 3/02

(52) U.S. Cl. 427/567; 427/294; 427/568; 423/348

(57) ABSTRACT

Particles coming from an evaporation source 9 are deposited on a substrate 21 at a specified film forming position 33 in a vacuum so as to form a thin film on the substrate 21. A rod-shaped material 32 containing a source material of the thin film is melted above the evaporation source 9 and the melted material is supplied to the evaporation source 9 in the form of droplets 14. As the rod-shaped material 32, a rod-shaped silicon material in which a plurality of first regions each surrounded by a grain boundary are present at positions of 90% length from a center toward an outer peripheral part on a cross section perpendicular to a longitudinal direction of the material, and an area-weighted average value of major diameters of the first regions is 200 μm or less, and a plurality of second regions each surrounded by a grain boundary are present at positions of 50% length from the center toward the outer peripheral part, and an area-weighted average value of major diameters of the second regions is 1000 μm or more is used.

### TECHNICAL FIELD

The present invention relates to a thin film manufacturing method and a silicon material that can be used in the method.

### BACKGROUND ART

Thin film techniques have been used widely to enhance the performance of devices and to reduce the size thereof. Thinned devices not only provide direct benefits to users but also play an important role in environmental aspects such as protection of earth resources and reduction in power consumption.

The advancement of the thin film techniques requires to meet demands such as high efficiency, stabilization, high productivity, and low costs in the manufacturing methods of the thin films. For example, long-time film formation techniques are essential to increase the productivity of thin films. For example, it is known to vapor-deposit silicon on various substrates to form a thin film in manufacturing solar cells and lithium ion secondary batteries. For performing a long-time film formation in manufacturing a thin film by a vacuum vapor deposition method, it is effective to supply a material to an evaporation source.

To supply the material to the evaporation source, various methods can be used in accordance with the source material to be used, film forming conditions, etc. Specifically, the following methods are known. (i) A method in which a material in various forms, such as powder, granule, and pellet, is added into the evaporation source. (ii) A method in which a rod-shaped or linear material is immersed in the evaporation source. (iii) A method in which a liquid material is poured into the evaporation source.

The temperature of the evaporation source varies in accordance with the addition of the material into the evaporation source. The temperature change in the evaporation source causes a change in the evaporation rate of the material, that is, a change in the film forming rate. Thus, it is important to minimize the temperature change in the evaporation source. For example, JP 62 (1987)-177174 A discloses a technique in which a material is once melted above a crucible, and then the melted material is supplied into the crucible. Also, there is a method in which a rod-shaped source material is melted continuously from its tip above an evaporation source, and the droplets generated by the melting are supplied to the evaporation source. These supplying methods are effective in reducing the thermal change in the evaporation source.

The rod-shaped silicon material can be produced by, for example, a method in which a silicon core wire is electrically heated, and trichlorosilane is allowed to react with hydrogen on the core wire so that polycrystalline silicon is deposited (see JP 3343508 B).

### CITATION LIST

### Patent Literature

PTL 1: JP 62 (1987)-177174 A
PTL 2: JP 3343508 B

### SUMMARY OF INVENTION

### Technical Problem

A method of supplying a rod-shaped material as a source material by melting continuously from its tip as disclosed in JP 62 (1987)-177174 A is advantageous in that the temperature change in the evaporation source is small. However, this method requires the melted source material to flow down exactly into the crucible of the evaporation source. Therefore, it is necessary to limit the heating range for the rod-shaped material and perform rapid heating so as to control the starting point of melting the material.

In the case of using a brittle material, such as silicon, as the source material, there is a possibility that the thermal expansion during the rapid heating breaks the rod-shaped material and the unmelted material falls into the crucible. The unmelted material that has fallen into the crucible absorbs the melting heat and thus lowers the temperature of the melt in the crucible, lowering the evaporation rate of the material in the crucible.

Furthermore, when the thermal expansion during the rapid heating crushes the rod-shaped material, the fine powder generated from the heated portion may scatter as so-called splashes and damage a vapor deposition substrate. Particularly, in the case of heating the material in the crucible by irradiation with an electron beam, the fine powder irradiated with the electron beam is electrically charged easily. Accordingly, the fine powder is more likely to scatter because of the electrostatic repulsion among the powder particles. Accordingly, the damage to the substrate due to the splashes becomes significant.

Particularly, in a rod-shaped silicon material produced by deposition using trichlorosilane as disclosed in JP 3343508 B, the diameters of crystal grains are small, and a surface layer of the material becomes coarse easily. Such a material has a low strength and tends to be broken during usage.

In this circumstance, there is needed a method that enables to supply stably the material to the evaporation source and prevent splashes from being generated as much as possible.

### Solution to Problem

The present invention has been accomplished in view of the above-mentioned object. That is, the present invention provides a method for manufacturing a thin film, including the steps of:

depositing particles coming from an evaporation source on a substrate at a specified film forming position in a vacuum so as to form the thin film on the substrate; and

melting a rod-shaped material containing a source material of the thin film above the evaporation source and supplying the melted material to the evaporation source in the form of droplets.

As the material, a rod-shaped silicon material in which (a) a plurality of first regions each surrounded by a grain boundary are present at positions of 90% length from a center toward an outer peripheral part on a cross section perpendicular to a longitudinal direction of the material, and an area-weighted average value of major diameters of the first regions is 200 μm or less, and (b) a plurality of second regions each surrounded by a grain boundary are present at positions of 50% length from the center toward the outer peripheral part, and an area-weighted average value of major diameters of the second regions is 1000 μm or more is used.

From another viewpoint, the present invention is a thin film forming method including the step of performing a vapor deposition while a rod-shaped material is being supplied. A rod-shaped silicon material is used as the material. The silicon material is melted continuously to be supplied to an evaporation source. The silicone material is characterized in that crystal grains with regions each surrounded by a grain boundary and having a major diameter of 200 μm or less occupy 50% or more of the area of an area lying at 90% length or more from a center to an outer peripheral part of the rod, and crystal grains with regions each surrounded by a grain boundary and having a major diameter of 1 mm or more occupy 50% or more of the area of an area lying at 40% to 60% length from the center to the outer peripheral part of the rod, on a cross section perpendicular to a longitudinal direction of the rod.

The present invention also is a thin film forming method including the steps of: transferring, in a vacuum chamber decompressed by a gas discharge means, an elongated substrate fed from a feed roll to a take-up roll through an opening defined by a shielding plate; and depositing, at the opening, vapor deposition particles emitted from a thin film forming source on a surface of the substrate being transferred so as to form a thin film. A rod-shaped material for forming the thin film is transferred, in an axial direction of the rod, above the thin film forming source and melted above the thin film forming source, and melted droplets of the material are dropped into the thin film forming source.

In still another aspect, the present invention provides a rod-shaped silicon material as a material that can be used suitably in the above-mentioned methods.

### Advantageous Effects of Invention

In the method of the present invention, it is possible to employ an inexpensive material-supplying technique in which a rod-shaped silicon material is melted continuously from its tip so as to be supplied in a continuous way. The method of the present invention uses a rod-shaped silicon material in which grains in an outer peripheral part have smaller grain sizes than those of grains in an inner part. Such a silicon material has a sufficient strength, and thereby it is possible to suppress the breakage (fracture) of the silicon material caused by rapid heating at the time when the material is supplied. Accordingly, it is possible to suppress the occurrence of splashes due to the breakage of the silicon material and to suppress the damage to the vapor deposition substrate caused by the splashes. Since the silicon material hardly breaks, a change is less likely to occur in the supplying state of the material, such as the state in which the rod-shaped silicon material is irradiated with an electron beam. Furthermore, the fact that the silicon material hardly breaks prevents the unmelted material from falling into the crucible, thereby suppressing a decrease in the evaporation rate caused by the temperature decrease of the melt. Accordingly, the stability of the material supply is enhanced.

### BRIEF DESCRIPTION OF DRAWINGS

FIG. 1 is a schematic view of a thin film manufacturing apparatus according to an embodiment of the present invention.

FIG. 2 is a schematic view of an evaporation source according to the embodiment of the present invention.

FIG. 3 provides cross-sectional views of a silicon material according to the embodiment of the present invention.

FIG. 4 is an enlarged view of the partial cross-sectional view shown on the right-hand side in FIG. 3.

### DESCRIPTION OF EMBODIMENTS

Hereinafter, an embodiment of the present invention is described with reference to the drawings.

### Embodiment

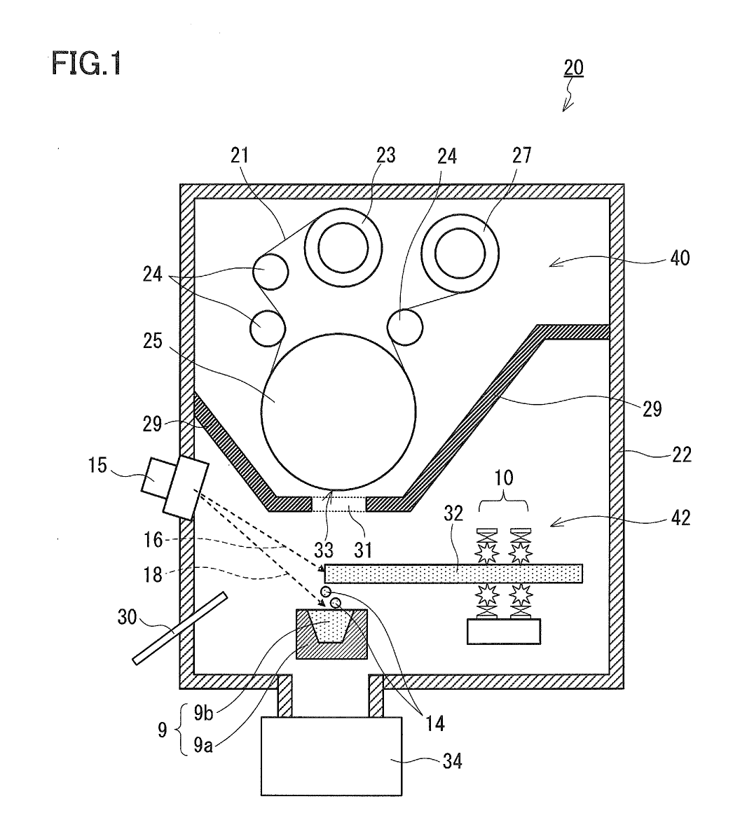

As shown in FIG. 1, a thin film manufacturing apparatus 20 includes a vacuum chamber 22, a substrate transfer unit 40, a shielding plate 29, an evaporation source (thin film forming source) 9, and a material supplying unit 42. The substrate transfer unit 40, the shielding plate 29, the evaporation source 9, and the material supplying unit 42 are disposed in the vacuum chamber 22. A vacuum pump (gas discharge means) 34 is connected to the vacuum chamber 22. An electron gun 15 and a source gas inlet 30 are provided on a side wall of the vacuum chamber 22.

The shielding plate 29 partitions the internal space of the vacuum chamber 22 into a first space (a lower space) in which the evaporation source 9 is disposed, and a second space (an upper space) in which the substrate transfer unit 40 is disposed. The shielding plate 29 has an opening 31, through which evaporated particles from the evaporation source 9 can travel from the first space to the second space.

The substrate transfer unit 40 has a function of feeding a substrate 21 to a specified film forming position 33 that faces the evaporation source 9, and a function of retracting, from the film forming position 33, the substrate 21 on which a film has been formed. The film forming position 33 is a position on the transfer path for the substrate 21, and also is a position defined by the opening 31 of the shielding plate 29. When the substrate 21 passes through this film forming position 33, the evaporated particles coming from the evaporation source 9 are deposited on the substrate 21. Thus, a thin film is formed on the substrate 21.

Specifically, the substrate transfer unit 40 is composed of a feed roll 23, transfer rollers 24, a cooling can 25, and a take-up roll 27. The substrate on which a film is to be formed is put on the feed roll 23. The transfer rollers 24 are disposed respectively on the upstream side and the downstream side of the transfer direction of the substrate 21. The transfer rollers 24 on the upstream side guide the substrate 21 fed from the feed roll 23 to the cooling can 25. The cooling can 25 supports and guides the substrate 21 to the film forming position 33, and then guides the substrate 21, on which the film has been formed, to the transfer roller 24 on the downstream side. The cooling can 25 has a circular cylindrical shape and is cooled with a refrigerant such as cooling water. The substrate 21 travels along the periphery of the cooling can 25, and is cooled by the cooling can 25 from a side opposite to a side facing the evaporation source 9. The transfer roller 24 on the downstream side guides the substrate 21, on which the film has been formed, to the take-up roll 27. The take-up roll 27 is driven by a motor (not shown), and takes up and holds the substrate 21 on which the thin film has been formed.

During the film formation process, the operation of feeding the substrate 21 from the feed roll 23 and the operation of taking up the substrate 21, on which the film has been formed, along the take-up roll 27 are performed in synchronization with each other. The rotations of the feed roll 23 and the take-up roll 27 can be controlled, and thereby a tension that allows the substrate 21 to be uniform along the cooling can 25 is applied to the substrate 21. The substrate 21 fed from the feed roll 23 is transferred to the take-up roll 27 through the film forming position 33. That is, the thin film manufacturing apparatus 20 is a so-called take-up thin film manufacturing apparatus for forming a thin film on the substrate 21 that is being transferred from the feed roll 23 toward the take-up roll 27. When such a take-up thin film manufacturing apparatus is used, high productivity can be expected because long-time film formation can be performed. A part of the substrate transfer unit 40, such as a motor, may be disposed outside the vacuum chamber 22. In this case, the driving force generated by the motor can be supplied to the various rolls in the vacuum chamber 22 via a rotation introduction terminal.

In the present embodiment, the substrate 21 is an elongated substrate having flexibility. The material of the substrate 21 is not particularly limited. A polymer film or a metal foil can be used. Examples of the polymer film include a polyethylene terephthalate film, a polyethylene naphthalate film, a polyamide film, and a polyimide film. Examples of the metal foil include an aluminum foil, a copper foil, a nickel foil, a titanium foil, and a stainless steel foil. A composite of a polymer film and a metal foil also can be used for the substrate 21.

The dimensions of the substrate 21 are not particularly limited, either, because they are determined according to the type of the thin film to be manufactured and the production volume of the thin film. The substrate 21 has a width of, for example, 50 to 1000 mm, and a thickness of, for example, 3 to 150 μm.

During the film formation process, the substrate 21 is transferred at a constant speed. The transfer speed is, for example, 0.1 to 500 m/min, although it varies depending on the type of the thin film to be manufactured and the film forming conditions. The film forming rate is, for example, 1 to 50 μm/min. An appropriate tension is applied to the substrate 21 that is being transferred, depending on the material of the substrate 21, the dimensions of the substrate 21, the film forming conditions, etc. The substrate 21 may be transferred intermittently to form a thin film on the substrate 21 in resting state.

The evaporation source 9 is configured so as to heat a material 9b in a crucible 9a with an electron beam 18 emitted from the electron gun 15. That is, the thin film manufacturing apparatus 20 according to the present embodiment is configured as a vacuum vapor deposition apparatus. The evaporation source 9 is disposed in a lower part of the vacuum chamber 22 so that the evaporated material travels vertically upward. Instead of the electron beam, other techniques such as resistance heating and induction heating may be used to heat the material 9b in the crucible 9a.

The shape of the opening of the crucible 9a is, for example, circular, oval, rectangular, or toroidal. During a continuous vacuum vapor deposition process, it is effective to use the crucible 9a having an opening wider than the width of the film to be formed for the sake of the uniformity of the film thickness in a width direction. As the material of the crucible 9a, metal, an oxide, a refractory material, or the like can be used. Examples of the metal include copper, molybdenum, tantalum, tungsten, and an alloy containing these metals. Examples of the oxide include alumina, silica, magnesia, and calcia. Examples of the refractory material include boron nitride and carbon. The crucible 9a may be water-cooled.

The source gas inlet 30 extends from the outside to the inside of the vacuum chamber 22. One end of the source gas inlet 30 is directed to the space between the evaporation source 9 and the substrate 21. The other end of the source gas inlet 30 is connected to a source gas supplier (not shown), such as a gas cylinder and a gas generating apparatus, outside the vacuum chamber 22. When an oxygen gas or a nitrogen gas is fed into the vacuum chamber 22 through the source gas inlet 30, a thin film containing an oxide, nitride, or oxynitride of the material 9b in the crucible 9a can be formed.

During the film formation process, the vacuum pump 34 is used to maintain the inside of the vacuum chamber 22 at a pressure, for example, 1.0×10⁻³ to 1.0×10⁻¹ Pa, suitable for forming a thin film. As the vacuum pump 34, various types of vacuum pumps can be used, such as a rotary pump, an oil diffusion pump, a cryopump, and a turbomolecular pump.

The material supplying unit 42 is used to melt, above the evaporation source 9, a bulk material 32 containing a source material of the thin film to be formed, and to supply the melted material to the evaporation source 9 in the form of droplets 14. In the present embodiment, a rod-shaped silicon material 32 is used as the bulk material 32. The material supplying unit 42 can supply silicon continuously to the evaporation source 9 in accordance with the consumption of the material 9b (a silicon melt) in the crucible 9a without purging the inside of the vacuum chamber 22 with air, etc. Furthermore, the material supplying unit 42 can supply silicon to the evaporation source 9 while allowing the silicon particles coming from the evaporation source 9a to be deposited on the substrate 21. Thereby, long-time continuous film formation can be performed.

It also is possible to stop forming the thin film temporarily to supply silicon to the crucible 9a. That is, it also is possible to perform alternately the process of supplying silicon to the crucible 9a and the process of depositing silicon on the substrate 21. Furthermore, it is conceivable to use a load lock system to transfer the substrate (a glass substrate, for example) to the film forming position 33 and retract this substrate from the film forming position 33.

The material supplying unit 42 is composed of a conveyor 10 and the electron gun 15. The conveyor 10 serves to hold the silicon material 32 horizontally as well as to transfer the silicon material 32 above the crucible 9a of the evaporation source 9. The electron gun 15 serves to heat the material 32 that has been transferred above the crucible 9a. In the present embodiment, the electron gun 15 also serves to heat and evaporate the material 9b in the crucible 9a.

The silicon material 32 is transferred above the crucible 9a by the conveyor 10, and is heated and melted with an electron beam 16. The silicon melt generated by the melting falls into the crucible 9a in the form of the droplets 14. Thereby, silicon as the source material of the thin film is supplied to the crucible 9a. Moreover, as a means for heating the silicon material 32, a laser irradiation apparatus also can be used instead of or together with the electron gun. In the case of using the electron beam or the laser beam, the fine powder generated by the breakage of the silicon material 32 is likely to scatter as splashes due to the rapid heating and electrical charge by the electron beam or the laser beam. Thus, in the case of using the electron beam or the laser beam, it particularly is recommended to use the silicon material 32 that hardly breaks. In the case of using the laser beam, irradiation via a polygon mirror may be needed to irradiate a broader area with the laser, and thus an energy loss is likely to occur. Therefore, in the case of producing a thin film by using a substrate with a larger width and a crucible with a larger width and in the case of producing a thin film at a high temperature and under high energy condition, for example, use of the electron beam makes it possible to achieve a high rate of thin film production.

It is desirable that the silicon material 32 have a mass of, for example, 0.5 kg or more, in other words, a sufficient heat capacity. In the silicon material 32 thus provided, an increase in the overall temperature can be suppressed when its tip portion is heated rapidly. In this case, since the tip portion of the silicon material 32 is melted selectively, it is easy to keep the same dropping position. That is, it is possible to supply stably the material to the crucible 9a without causing the droplets 14 to fall outside the crucible 9a. The upper limit of the mass of the silicon material 32 is not particularly limited. It is, for example, 10 kg when the size of the thin film manufacturing apparatus 20 is taken into consideration.

In the present embodiment, the silicon material 32 has a rod shape. The silicon material 32 in such a shape has a small surface area, and thus the amount of moisture adhered to the surface also is small. Typically, the silicon material 32 has the shape of a rod with a circular cross section. The silicon material 32 with a circular cross section has a diameter of, for example, 40 mm to 100 mm, and preferably 50 mm to 60 mm.

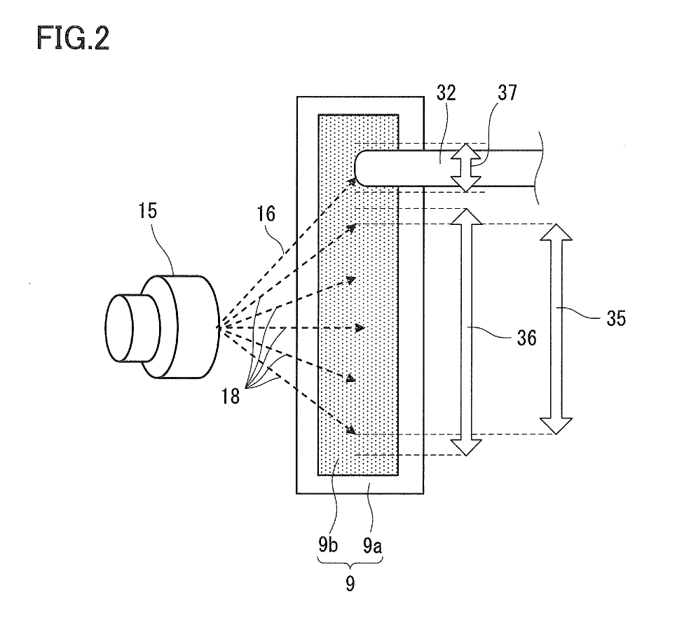

As shown in FIG. 2, the crucible 9a has the rectangular opening wider than an opening width 35 of the opening 31 of the shielding plate 29. The position of the tip portion of the silicon material 32 is determined not to overlap with the opening 31 of the shielding plate 29 when viewed in plane. In order to evaporate the material 9b in the crucible 9a, a scanning zone 36 is irradiated with the electron beam 18. The scanning zone 36 is set to be wider than the opening width 35 of the shielding plate 29 with respect to a longer direction (width direction) of the crucible 9a. This enhances the uniformity of the thin film thickness in the width direction. For further effectiveness in enhancing the uniformity of the thin film thickness in the width direction, both ends of the scanning zone 36 with respect to the width direction are irradiated with the electron beam 18 for a longer time than that spent at other positions.

On the other hand, an irradiation position 37 of the electron beam 16 for melting the silicon material 32 is set to be outside of the scanning zone 36 of the electron beam 18. In other words, the dropping position of the silicon droplets 14 is set to be outside of the scanning zone 36 of the electron beam 18. This configuration makes it possible to reduce the influence, to the film formation, caused by the temperature change in the material 9b (the silicon melt) and the vibration of the liquid surface of the material 9b when the droplets 14 are supplied.

The rate (material supplying rate) at which the silicon drops are supplied into the crucible 9a is 1 to 500 g/min, for example. The energy of the electron beams is 1 to 100 W/mm², for example.

As the silicon material 32, a rod-shaped silicon material in which grains in an outer peripheral part have smaller grain sizes than those of grains in an inner part on a cross section perpendicular to a longitudinal direction of the rod is used. Specifically, a rod-shaped material is used in which crystal grains in an area lying at 90% length or more from a center to an outer peripheral part of the rod have smaller diameters than those of crystal grains at positions of 50% length of the rod, on a cross section perpendicular to a longitudinal direction of the rod. Here, the phrase “90% length” refers to a distance of 90% of the distance from the center to the outer peripheral part of the rod. Further preferably, crystal grains in an area lying at 10% length or less from the center toward the outer peripheral part of the rod also have smaller diameters than those of the crystal grains at positions of 50% length from the center of the rod.

Since the grain boundaries in the silicon material are fragile, a dynamic impact applied thereto causes a starting point of breakage on the material. However, since the heat transfer of the grain boundaries is low, they are effective in stopping the breakage of the material due to the applied thermal impact so as to be within a minimum area.

In the silicon material 32 of the present embodiment, crystal grains in a surface layer are small. That is, many crystal grain boundaries are present in the outer peripheral part on the cross section perpendicular to the longitudinal direction (longer direction) of the silicon material. Thus, the thermal impact applied to the surface of the silicon material 32 is blocked by the grain boundaries in the surface layer. Whereas the surface portion of the silicon material 32 is rapidly heated selectively, the rapid heating is suppressed inside the silicon material 32, thereby suppressing the breakage of the silicon material 32 due to the thermal impact.

Since a silicon material with crystal grains having small grain diameters includes many crystal grain boundaries, it is vulnerable to a dynamic impact and can be broken easily by mechanical vibration and an impact of a falling object, etc. In contrast, the silicon material 32 of the present embodiment has an area (large diameter area) in which crystal grains have large diameters, that is, an area with less grain boundaries, lying at an area on an inner side of the surface layer area in which crystal grains have small diameters. Therefore, the silicon material of the present invention has an increased physical strength, and thereby a higher strength against a mechanical vibration and a dynamic impact can be ensured.

In the case where an area in which crystal grains have small diameters is further formed on an inner side of the area (large diameter area) in which crystal grains have large diameters, it is possible to suppress more effectively the breakage of the silicon material caused by rapid heating. That is, when the thermal impact applied during heating reaches, for a reason, as far as the large diameter area vulnerable to a thermal impact and causes cracks, the inner area in which crystal grains have small diameters suppresses the growth of the cracks.

Based on the above, it is preferable that in the rod-shaped silicon material, (a) a plurality of first regions each surrounded by a grain boundary are present at positions of 90% length from the center toward the outer peripheral part on the cross section perpendicular to the longitudinal direction of the material, and an area-weighted average value of major diameters of the first regions is 200 μm or less, and (b) a plurality of second regions each surrounded by a grain boundary are present at positions of 50% length from the center toward the outer peripheral part on the cross section, and an area-weighted average value of major diameters of the second regions is 1000 μm or more. In other words, regions each surrounded by a grain boundary and having a major diameter of 200 μm or less occupy 50% or more of the total area of regions each surrounded by a grain boundary and each present at a position of 90% length from the center toward the outer peripheral part on the cross section perpendicular to the longitudinal direction of the rod, and regions each surrounded by a grain boundary and having a major diameter of 1000 μm or more occupy 50% or more of the total area of regions each surrounded by a grain boundary and each present at a position of 50% length.

In addition to the above, it is more preferable that an area-weighted average value of the major diameters of regions each surrounded by a grain boundary and each present at a position of 10% length from the center toward the outer peripheral part on the cross section is 200 μm or less. In other words, it is further preferable that regions each surrounded by a grain boundary and having a major diameter of 200 μm or less occupy 50% or more of the total area of regions each surrounded by a grain boundary and each present at a position of 10% length from the center toward the outer peripheral part on the cross section.

The lower limit of the area-weighted average value of the major diameters of the first regions is not particularly limited, and it is 50 μm, for example. The upper limit of the area-weighted average value of the major diameters of the second regions is not particularly limited, and it is 5000 μm, for example. The lower limit of the area-weighted average value of the major diameters of the third regions is not particularly limited, and it is 50 μm, for example.

In the case where a silicon material with an area in which grains have small diameters is produced by using a method of precipitating silicon on a surface of a silicon base material as disclosed in Patent Literature 2, a coarse structure referred to as “popcorn” tends to be formed. Thus, the silicon material 32 in the present embodiment preferably is produced by a casting method.

Specifically, the silicon material 32 is produced by casting silicon in the air. As the silicon used for the casting, low purity metal silicon for metallurgical use commonly can be used. As the metal silicon, high purity silicon used for solar cells and semiconductors also can be used without any problems. Furthermore, it is also possible to melt a silicon oxide, such as quartzite and silica, with a reducing agent to obtain a silicon melt, and pour the melt into a mold. For example, the metal silicon is put into a fire-resistant crucible. The metal silicon is heated at 1500° C. to 1800° C. to be melted, and slag such as silica produced during that on the surface of the melt due to a reaction of silicon with oxygen in the air is removed. The crucible is tilted to pour the silicon melt into a mold to obtain a silicon cast rod. As the fire-resistant crucible, a fire-resistant crucible made of alumina, silica, or a mixture of these can be mentioned. As the method for heating the metal silicon, it is possible to use various heating methods such as heating by a resistance heater, heating by combustion of gas, such as, hydrogen and methane, a high frequency induction heating by a coil, and arc melting by arc discharge. The tilt-pouring rate of the silicon melt into the mold is about 0.1 to 0.7 kg/sec, for example. Preferably, the tilt-pouring rate of the silicon melt into the mold is about 0.01 to 0.05 kg/sec, for example, in order to prevent pores from generating inside the silicon cast rod.

In order to suppress the generation of slag such as silica, it is effective to perform the melting and the casting in an inert atmosphere, such as an argon atmosphere, or in a vacuum furnace, to use a crucible made of a nonoxidative material such as graphite and silicon, or to carry out both of these measures.

A heat-resistant material, such as graphite and ceramics, can be used for the mold. There is no problem with applying a release agent, such as a boron nitride, to the surface of the mold in order to suppress the adhesion of the silicon to the mold. The heat capacity of the mold is adjusted so as not to heat the mold to 1000° C. or higher when the silicon melt is poured thereinto. The internal shape of the mold may be determined according to a preferable shape and size of the rod-shaped silicon material described above. Hereinafter, the rod-shaped silicon material may be simply referred to as a “silicon rod”.

When the silicon melt is poured into such a mold to produce a silicon rod, the surface layer of the silicon rod is cooled rapidly, thereby forming fine grain boundaries in the surface layer of the silicon rod. An inner portion of the silicon rod is cooled more slowly than the surface layer because of the heat radiation occurring along with the solidification of the surface layer. Thus, large grain boundaries are formed in the inner portion of the silicon rod. On the other hand, silicon has a property of being expanded when being solidified, as in the case of water. Accordingly, a central portion of the silicon rod is under a high pressure because of the continuous solidification of the silicon from the surface layer toward the center. This makes it impossible for crystals to grow in the central portion of the silicon rod, so that an area with fine grain boundaries is formed again.

Preferably, the mold into which the silicon melt has been poured is cooled by natural cooling. It is possible to adjust the size and distribution of the grain boundaries of the silicon crystals formed in the silicon rod by, for example, controlling the cooling rate. It is possible to change the cooling rate by adjusting appropriately the filling factor, heat conductivity, thickness and initial temperature of a heat insulating material disposed around the mold, for example.

The cooling rate is set, for example, to 3 hours to 18 hours when expressed by a cooling time, which is a time from when the silicon melt with a temperature of 1500 to 1800° C. is poured into the mold until the cast silicon in the mold has a temperature of 100° C. Preferably, the cooling time is 5 hours to 12 hours to form the area in which crystal grains have small diameters on the inner side of the large diameter area.

The solidification center of the silicon rod almost coincides with the center of the silicon rod shape, although it somewhat varies due to the distortion of the rod shape, etc. caused during the solidification. For example, in the case of a silicon rod with an approximately circular cross section, the solidification center of the silicon on the cross section almost coincides with the center of a circumscribed circle of the cross section.

In this description, the center of a cross section refers to the center of a circumscribed circle of the cross section. Also, in this description, a position of x % length refers to a position at which the length from the center to the position is x % of the length from the center to the outer peripheral part. When the cross section is a perfect circle, the length from the center to the outer peripheral part is constant. However, the cross section of the silicon rod is not always a perfect circle. Therefore, the distance from the center to the position of x % length is not always constant, either.

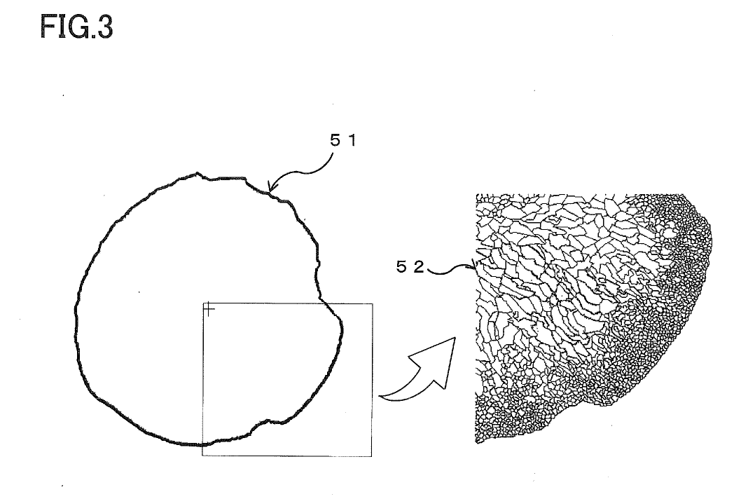

FIG. 3 provides views showing schematically the distribution of the crystal grain boundaries on a cross section perpendicular to the longitudinal direction of the rod-shaped silicon material. The cross section perpendicular to the longitudinal direction of the silicon rod has an almost circular shape surrounded by an outer periphery 51. The outer periphery 51 is a portion at which the silicon material is in contact with the mold when produced by the casting method. On the cross section, isotropically-arranged grain boundaries are formed in a surface layer portion and a central portion. An area (large diameter area) in which crystal grains have large diameters lies between the surface layer portion and the central portion. At the time of solidification, one-way solidification from the surface layer toward the center of the silicon rod proceeds in the large diameter area. Thus, long narrow grain boundaries 52 are formed in the large diameter area to extend radially from the center toward the surface layer.

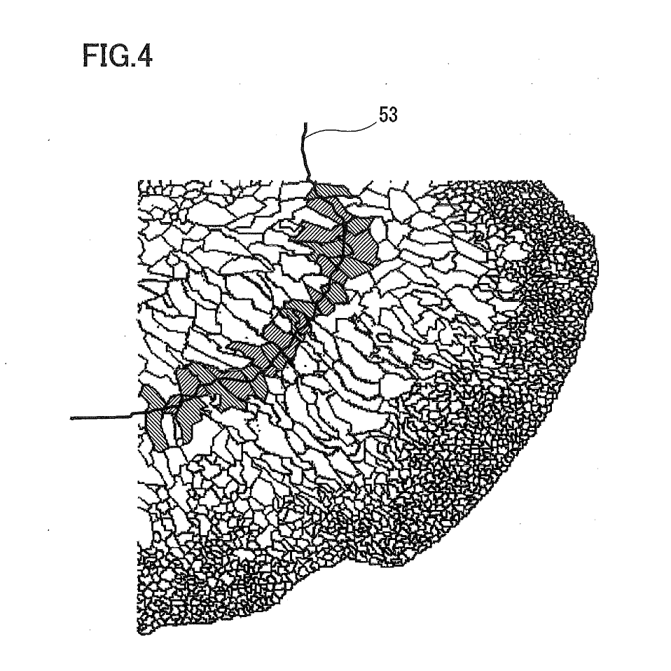

The plurality of second regions in the present invention are described with reference to FIG. 4. FIG. 4 is an enlarged view of the partial cross-sectional view shown on the right-hand side in FIG. 3. In FIG. 4, a position of 50% length is a point on a curved line 53. The second regions are regions each surrounded by a grain boundary and present on the curved line 53 indicating the position of 50% length. That is, the second regions are diagonally-shaded regions in FIG. 4.

### Examples

Various kinds of silicon rods with different crystal grain diameters and distributions were produced by the casting method. The silicon used for the casting was #2202 grade metal silicon with impurity contents that are less than 2000 ppm of iron, less than 2000 ppm of aluminum, and less than 200 ppm of calcium. In Examples 1 to 16 and Comparative Examples 6 to 10 and 14 to 16, metal silicon melt was poured into a mold and cooled to form a silicon rod. That is, the metal silicon melt obtained by heating metal silicon at 1800° C. was tilt-poured into a graphite mold at a rate of 0.03 kg/second (2 kg/minute). A zirconia heat insulating material was disposed around the graphite mold. The cooling time was adjusted by changing the filling ratio and thickness of the heat insulating material. In Comparative Examples 1 to 5 and 11 to 13, the metal silicon melt was not poured into the mold but cooled gradually in a furnace for 24 hours to form a silicon rod.

The crystal grain diameters and distributions, that is, the major diameters of the regions each surrounded by a grain boundary on the cross section perpendicular to the longitudinal direction of the silicon rod, were controlled by adjusting the cooling time as shown in Table 1 and 2. The cooling time refers to a time required from when the cooling of the melt started until when the temperature of the cast product or the solidified product reached 100° C. The temperature of the cast product or the solidified product was obtained by placing, on an inner wall of the graphite mold, a thermocouple protected by a graphite sheath and measuring the temperature of the surface of the cast product or the solidified product. In Examples 1 to 10 and Comparative Examples 1 to 10, silicon rods with a diameter of 55 mm and a length of 200 mm were produced. In Examples 11 to 16 and Comparative Examples 11 to 16, silicon rods with a diameter of 60 μm and a length of 200 mm were produced.

Each of the produced silicon rods was cut vertically to the longitudinal direction. On the cross section thereof, area-weighted average values of major diameters of regions that were each surrounded by a grain boundary and were present at positions of 10%, 50% and 90% length, respectively, were calculated.

The area-weighted average value of major diameters are represented by the following formula (I). That is, the area-weighted average value of major diameters of regions each surrounded by a grain boundary and each present at a position of x % length is determined as follows. First, the total area of the regions each surrounded by a grain boundary and each present at a position of x % length is calculated. Next, with respect to each of the regions that is surrounded by a grain boundary and present at a position of x % length, its major diameter is multiplied by its area to obtain a value, and these values are summed up to obtain a total value. The total value is divided by the total area to obtain the area-weighted average value of major diameters.

$$\begin{matrix}[ Equation 1 ] & \\ Area \text{-} weighted average value of major diameters = \frac{\begin{matrix}Major diameter of grain 1 \times Area of grain 1 + \\ Major diameter of grain 2 \times Area of grain 2 + …\end{matrix}}{Total area} & ( 1 )\end{matrix}$$

The area-weighted average value can be obtained by, for example, capturing into a computer an image of a cross section of the rod-shaped silicon material obtained when the material is cut along a plane perpendicular to the longitudinal direction, and making the calculation of the formula (1) mentioned above. The major diameter is defined as the distance between two points that are most distanced from each other in a grain. That is, the outer periphery of a target grain observed in the cross sectional image is detected and the distance between two points on the outer periphery is measured. All points on the outer periphery are measured for this distance, and the distance between two points that are most distanced from each other is determined as the major diameter of the grain.

Using each of the produced silicon rods as a supply material, a vapor deposition test by electron beam irradiation was conducted with the evaporation apparatus shown in FIG. 1. The intensity of the electron beam was 16 W/mm² in the irradiation area on the material surface, and the material supplying rate was 30 g/min. The silicon rod was moved forward at a rate of 50 mm/minute under irradiation of the electron beam. The silicon rod was checked for breakage. It was determined that “breakage observed” when an unmelted fragment with a diameter of about 5 mm or more was found fallen in the vacuum chamber after 5 minutes of the electron beam irradiation.

Table 1 and 2 show the results thereof. Hereinafter, the positions of 10%, 50% and 90% length from the center toward the outer peripheral part on the cross section of the silicon rod are referred to as a 10% position, a 50% position and 90% position, respectively, for the sake of simplicity.

TABLE 1
Relationship between grain diameter distribution and occurrence of
breakage in samples during vapor deposition (φ 50 mm)

| | | Area-weighted average value of regions | | | | |
|---|---|---|---|---|---|---|
| | | each surrounded by grain boundary (μm) | | | Breakage | Occurrence |
| | | 10% | 50% | 90% | during vapor | rate of |
| Sample No. | Sample classification | position | position | position | deposition | breakage (%) |
| Example 1 | 10% position 200 μm or less | 200 | 2030 | 180 | Not observed | 0 |
| Example 2 | 50% position 1000 μm or more | 180 | 1020 | 90 | Not observed | |
| Example 3 | 90% position 200 μm or less | 190 | 3500 | 120 | Not observed | |
| Example 4 | (Cooling time 5 hours) | 150 | 2760 | 130 | Not observed | |
| Example 5 | | 120 | 1120 | 180 | Not observed | |
| Example 6 | 10% position 200 μm or more | 2620 | 2810 | 190 | Not observed | 20 |
| Example 7 | 50% position 1000 μm or more | 1860 | 1050 | 90 | Not observed | |
| Example 8 | 90% position 200 μm or less | 1330 | 1590 | 180 | Observed | |
| Example 9 | (Cooling time 12 hours) | 900 | 1230 | 190 | Not observed | |
| Example 10 | | 870 | 1310 | 200 | Not observed | |
| C. Example 1 | 50% position 1000 μm or more | 2920 | 2830 | 3220 | Not observed | 80 |
| C. Example 2 | 90% position more than 200 μm | 1470 | 1330 | 1310 | Observed | |
| C. Example 3 | (Cooling time 24 hours) | 1000 | 1270 | 1170 | Observed | |
| C. Example 4 | | 980 | 1020 | 1150 | Observed | |
| C. Example 5 | | 3250 | 2970 | 2990 | Observed | |
| C. Example 6 | 50% position less than 1000 μm | 230 | 320 | 320 | Observed | 100 |
| C. Example 7 | (Cooling time 1 hour) | 200 | 150 | 210 | Observed | |
| C. Example 8 | | 160 | 280 | 240 | Observed | |
| C. Example 9 | | 140 | 220 | 170 | Observed | |
| C. Example 10 | | 90 | 120 | 110 | Observed | |

TABLE 2
Relationship between grain diameter distribution and occurrence of
breakage in samples during vapor deposition (φ 60 mm)

| | | Area-weighted average value of regions | | | | |
|---|---|---|---|---|---|---|
| | | each surrounded by grain boundary (μm) | | | Breakage | Occurrence |
| | | 10% | 50% | 90% | during vapor | rate of |
| Sample No. | Sample classification | position | position | position | deposition | breakage (%) |
| Example 11 | 10% position 200 μm or less | 200 | 3210 | 190 | Not observed | 0 |
| Example 12 | 50% position 1000 μm or more | 150 | 2700 | 180 | Not observed | |
| Example 13 | 90% position 200 μm or less | 190 | 1020 | 170 | Not observed | |
| | (Cooling time 5 hours) | | | | | |
| Example 14 | 10% position 200 μm or more | 2150 | 2600 | 200 | Not observed | 0 |
| Example 15 | 50% position 1000 μm or more | 2100 | 1560 | 170 | Not observed | |
| Example 16 | 90% position 200 μm or less | 1220 | 1410 | 140 | Not observed | |
| | (Cooling time 12 hours) | | | | | |
| C. Example 11 | 50% position 1000 μm or more | 2130 | 1620 | 1020 | Not observed | 66 |
| C. Example 12 | 90% position more than 200 μm | 2060 | 1590 | 1480 | Observed | |
| C. Example 13 | (Cooling time 24 hours) | 1050 | 1330 | 1290 | Observed | |
| C. Example 14 | 50% position less than 1000 μm | 310 | 420 | 180 | Observed | 100 |
| C. Example 15 | (Cooling time 1 hour) | 170 | 390 | 260 | Observed | |
| C. Example 16 | | 160 | 250 | 220 | Observed | |

As is apparent from comparison between Table 1 and Table 2, the occurrence rates of breakage in the silicon rods during the vapor deposition test were not dependent on the diameter differences among the silicon rods but related to the grain diameters of the silicon crystals and their distribution.

As shown in Table 1 and 2, in the silicon rods of Examples 6 to 10 and 14 to 16, in which the cooling time was 12 hours, crystals grew at the 50% position and the 10% position and did not grow significantly at the 90% position. The area-weighted average value was 1000 μm or more at the 50% position and 200 μm or less at the 90% position, and in this case the occurrence of breakage was suppressed in most of the silicon rods.

In the silicon rods of Examples 1 to 5 and 11 to 13, in which the cooling time was 5 hours, crystals grew at the 50% position and did not grow significantly at the 10% position and the 90% position. When the diameters of crystal grains near the central axis were small as is just described, the occurrence of breakage was suppressed in all of the silicon rods.

As shown in Comparative Examples 6 to 10 and 14 to 16, breakage occurred in all of the silicon rods when the area-weighted average value at the 50% position was less than 1000 μm. Moreover, as shown in Comparative Examples 1 to 5 and 11 to 13, breakage was observed in most of the silicon rods when the area-weighted average value at the 50% position was 1000 μm or more but the area-weighted average value at the 90% position was more than 200 μm.

### INDUSTRIAL APPLICABILITY

The present invention can be applied to the manufacture of elongated electrode plates for energy storage devices. As the substrate 21, a metal foil, such as a copper foil and a copper alloy foil, is used. The material 9b (silicon) in the crucible 9a is evaporated using the electron beam 18, so that a silicon thin film is formed on the substrate 21 serving as a negative electrode collector. Introducing a small amount of oxygen gas into the vacuum chamber 22 makes it possible to form a silicon thin film containing silicon and a silicon oxide on the substrate 21. Since silicon is capable of absorbing and releasing lithium therein and therefrom, the substrate 21 on which the silicon thin film has been formed can be utilized as a negative electrode of a lithium ion secondary battery.

The present invention can be applied to the manufacture of thin films that contain at least one of silicon and a silicon oxide as a main component and that are used in electrode plates for energy storage devices, magnetic tapes, capacitors, various sensors, solar cells, various optical films, moisture-proof films, and conductive films. Particularly, the present invention can be applied advantageously to the manufacture of thin films in electrode plates for energy storage devices that require long-time film formation and formation of relatively thick films.

1. A method for manufacturing a thin film, comprising the steps of:
depositing particles coming from an evaporation source on a substrate at a specified film forming position in a vacuum so as to form the thin film on the substrate; and
melting a rod-shaped material containing a source material of the thin film above the evaporation source and supplying the melted material to the evaporation source in the form of droplets,
wherein as the rod-shaped material, a rod-shaped silicon material in which (a) a plurality of first regions each surrounded by a grain boundary are present at positions of 90% length from a center toward an outer peripheral part on a cross section perpendicular to a longitudinal direction of the material, and an area-weighted average value of major diameters of the first regions is 200 μm or less, and (b) a plurality of second regions each surrounded by a grain boundary are present at positions of 50% length from the center toward the outer peripheral part, and an area-weighted average value of major diameters of the second regions is 1000 μm or more is used.

2. The method for manufacturing the thin film according to claim 1, wherein a plurality of third regions each surrounded by a grain boundary are present at positions of 10% length from the center toward the outer peripheral part on the cross section of the silicon material, and an area-weighted average value of major diameters of the third regions is 200 μm or less.

3. The method for manufacturing the thin film according to claim 1, wherein the silicon material is produced by a casting method.

4. The method for manufacturing the thin film according to claim 1, wherein the silicon material is melted by irradiation with an electron beam or a laser beam.

5. The method for manufacturing the thin film according to claim 1, wherein
the substrate is an elongated substrate,
the depositing step includes transferring the elongated substrate fed from a feed roll to a take-up roll through the specified film forming position, and
the supplying step is performed while the depositing step is performed.

6. A method for manufacturing a negative electrode for a lithium ion secondary battery, comprising the step of depositing silicon as a negative electrode active material capable of absorbing and releasing lithium therein and therefrom, on a substrate serving as a negative electrode collector, by the method for manufacturing the thin film according to claim 1.

7. A rod-shaped silicon material, comprising:
a plurality of first regions each surrounded by a grain boundary, the first regions being present at positions of 90% length from a center toward an outer peripheral part on a cross section perpendicular to a longitudinal direction; and
a plurality of second regions each surrounded by a grain boundary, the second regions being present at positions of 50% length from the center toward the outer peripheral part,
wherein an area-weighted average value of major diameters of the first regions is 200 μm or less, and an area-weighted average value of major diameters of the second regions is 1000 μm or more.

8. The silicon material according to claim 7, wherein a plurality of third regions each surrounded by a grain boundary are present at positions of 10% length from the center toward the outer peripheral part on the cross section of the silicon material, and an area-weighted average value of major diameters of the third regions is 200 μm or less.

9. The silicon material according to claim 7, wherein the silicon material is produced by a casting method.
